(19) United States
(12) Patent Application Publication
(10) Pub. No.: US 2026/0244276 A1
(43) Pub. Date: Aug. 20, 2026

(54) DRIVER MONITORING DEVICE, VEHICLE, METHOD, PROGRAM CODE AND COMPUTER-READABLE STORAGE MEDIUM

(71) Applicant: AUDI AG, Ingolstadt (DE)

(72) Inventors: Michael BRUCKHUBER, München (DE); Vladimir IDELEVITCH, Nürnberg (DE)

(73) Assignee: AUDI AG, Ingolstadt (DE)

(21) Appl. No.: 19/545,546

(22) Filed: Feb. 20, 2026

(30) Foreign Application Priority Data
Feb. 20, 2025 (DE) 10 2025 106 543.8

(51) Int. Cl. G06F 3/01; B60W 50/08; B60W 50/14; G06V 20/59; G06V 40/20

(52) U.S. Cl. CPC G06F 3/017; B60W 50/085; B60W 50/14; G06V 20/597; G06V 40/28; B60W 2050/146; B60W 2420/403; B60W 2540/223; B60W 2540/229

(57) ABSTRACT

A driver monitoring device for a vehicle may include a camera device and a control device. The camera device is configured to detect a detection area of a vehicle cabin of the vehicle and to send camera data to the control device. The control device is configured to check a current degree of automation of the vehicle and, if a specific degree of automation is present, to check the vehicle driver in the camera data for meeting a vehicle driver attentiveness criteria, and if at least a minimum number of vehicle driver attentiveness criteria are met, to establish a vehicle driver attentiveness and otherwise to determine that the vehicle driver attentiveness is not present. A vehicle driver attentiveness criteria may include a finger gesture of the vehicle driver being detected by the control device.

### CROSS-REFERENCE TO RELATED APPLICATIONS

This application claims the priority benefit of German Patent Application No. 10 2025 106 543.8 filed on Feb. 20, 2025, which is incorporated by reference herein in its entirety.

### BACKGROUND

### 1. Field

An invention according to described examples relates to a driver monitoring device for a vehicle, a vehicle comprising a driver monitoring device, a method for operating a driver monitoring device, a program code, and a computer-readable storage medium.

### 2. Description of Related Art

According to UN regulation number 157 (UN Regulation No 157—Uniform provisions concerning the approval of vehicles with regards to Automated Lane Keeping Systems (ALKS) [2021/389] (OJ L 82 09.03.2021, p. 75), it is necessary for the driver of a vehicle to be monitored to recognize whether the driver is available and in an appropriate driving position to respond to a transition demand by the vehicle.

The driver is deemed to be unavailable unless at least two availability criteria have individually determined that the driver is available in the last 30 seconds. The availability criteria are to be understood to be, for example, blinking or eye closure by the driver and conscious head or body movement. As soon as the driver is deemed to be unavailable, or fewer than two availability criteria can be monitored, the system is to immediately provide a distinctive warning until appropriate actions of the driver are detected or until a transition demand is initiated. At the latest, the transition demand is to be initiated if this warning continues for 15 seconds.

In particular in conjunction with automated/autonomous driving, the vehicle driver-vehicle interaction—in particular for entertainment purposes—is becoming increasingly important. Driver assistance systems and especially autonomous driving (for example, automation levels SAE L3, L4, and L5) offer the explicit added value in that the customer no longer has to concentrate on the traffic events, but rather can turn to other activities. The customer can use known interaction options to operate the other activities. The options for interaction with the vehicle include traditional buttons, touch-sensitive display screens, speech commands, and gesture recognition.

Current gesture controls, which are detected by vehicles by a camera device, often comprise arm or hand movements which are relatively large in scale. There is presently not yet a solution for a small-scale gesture control for the vehicle driver-vehicle interaction, as is typical in smart phones using the touchscreen solution. In order to interact with an app mirrored in the vehicle or provided by the system of the vehicle, the vehicle driver either has to use speech control or cumbersomely execute the large-scale gestures already described with the entire arm or the entire hand. A type of “scrolling movement” with the thumb or index finger or “swiping” to the side with the thumb or index finger is not provided, even though such movements are indispensable for interaction with many social media apps. These application cases are gaining substantial relevance in particular in combination with functions which enable automated/autonomous driving (for example, automation levels SAE L3, L4, and L5) and enable a focus outside of the driving task.

The lack of the detection of said small-scale gestures is also disadvantageous with respect to the described monitoring of the availability of the vehicle driver. According to the prior art, often only interactions of the vehicle driver with the vehicle are assessed to establish the vehicle driver availability. If the vehicle driver interacts with his or her smart phone by finger gestures, these interactions are not assessed as being a fulfilled availability criterion and the monitoring device can determine that the vehicle driver is unavailable under certain circumstances.

DE 10 2013 201 746 A1 describes a gesture-based recognition system for interpreting a gesture of a vehicle driver.

WO 2013/036 289 A2 describes an operating interface for a driver of a motor vehicle.

### SUMMARY

The present invention according to the examples is based on an example object of providing small-scale gesture-based operation for a vehicle oriented to display screen applications. The invention according to the examples is moreover based on an example object of assessing an interaction of the vehicle driver when determining vehicle driver availability.

The example object may be achieved by the subjects of the independent claims. Advantageous refinements of the invention according to the examples may be described by the dependent claims, the following description, and the figures.

A first aspect of the invention according the examples relates to a driver monitoring device for a vehicle. The driver monitoring device comprises a camera device and a control device. The camera device is configured to detect a detection area of the vehicle cabin of the vehicle and to send corresponding camera data to the control device. The camera device can comprise one or more camera units which are provided to detect the detection area, which can be a specified spatial area of the vehicle cabin. The camera device is configured to output the camera data which describe the detected detection area. The camera data can comprise image recordings of the detection area.

The control device is configured to evaluate the provided camera data which depict the detection area of the vehicle cabin and to identify gestures of a vehicle driver within the detection area according to a gesture database stored in the control device. In other words, the control device is configured for gesture recognition. It is provided that the control device is configured to identify the gestures in the camera data which are described in the gesture database. The gestures can comprise predetermined movement patterns of an arm or a hand of the vehicle driver.

The control device can be configured to track specific points in the camera data and to determine the user gestures carried out by the vehicle driver and compare them to those gestures defined in the gesture database. The control device is configured to identify the gesture when a user gesture carried out by the vehicle driver and detected by the control device has a required correspondence with a gesture stored in the gesture database. The control device is configured to output, depending on the identified gesture within the detection area, an assigned control signal which comprises a control instruction associated with the identified gesture. In other words, the control device is configured to output the control signal associated with the identified gesture upon the identification of the gesture. The control signal comprises a control instruction of the relevant identified gesture.

The control device is configured to check a current degree of automation of the vehicle and, upon a presence of a specific degree of automation, to check the vehicle driver in the camera data for meeting predetermined vehicle driver attentiveness criteria, and if at least a minimum number of the vehicle driver attentiveness criteria are met, to establish vehicle driver attentiveness and otherwise to determine that the vehicle driver attentiveness is not present. The check as to whether the predetermined vehicle driver attentiveness criteria are met can take place, for example, according to the UN guideline. It can be provided, for example, that the control device is configured to check, upon establishing the specific degree of automation, whether the vehicle driver meets at least two of the vehicle driver attentiveness criteria during a period of time of 30 seconds. It can be provided, for example, that it is required for this purpose that the vehicle driver has to carry out specific head movements and has to have his or her eyes open during the period of time. The control device is configured, in the case that the minimum number of the vehicle driver attentiveness criteria are met, to establish the vehicle driver attentiveness and to maintain the current degree of automation of the vehicle. The control device is configured, in the case that the vehicle driver attentiveness is not established, for example, to output a warning signal and/or to change the degree of automation of the vehicle.

It is provided that one of the vehicle driver attentiveness criteria comprises a respective predetermined finger gesture of the vehicle occupant for controlling a function of a display screen user interface being detected by the control device, which is authorized by the control device only in the specific degree of automation. In other words, it is provided that, in addition to the already known vehicle driver attentiveness criteria, a further possible vehicle driver attentiveness criterion, which consists in the control device determining that the vehicle driver carries out predetermined finger gestures in order to prevent vehicle driver attentiveness. To control a specific application. It can be provided, for example, that if the predetermined degree of automation is established by the control device, a use of an application which comprises an entertainment function, for example, is authorized, which can be blocked in other degrees of automation. The vehicle driver can carry out the predetermined finger gestures in this case to control the application. The control device is configured to detect the finger gestures carried out by the vehicle driver and assess them as meeting a vehicle driver attentiveness criterion. The finger gestures can comprise, for example, tapping, swiping, or scrolling gestures. The finger gestures can be intended to control an application displayed on a user interface. The finger gestures can also be carried out for the control of a smart phone mirrored on the vehicle interface in order to control the application on the smart phone.

One refinement of the invention according to the examples provides that the respective predetermined finger gesture is intended to control a function of a display screen user interface of the vehicle which is authorized by the control device only in the specific degree of automation. In other words, the control device is configured so that the function of the display screen user interface is authorized upon the presence of the specific degree of automation. The function of the display screen user interface can also be authorized on the other side of the function of the display screen user interface, which authorizes the function of the screen user interface. To control the authorized function. The control device can be configured to detect the finger gesture and guide a command combined with the finger gesture to the function. The advantage thus results that certain gestures typical in the degree of automation are used to check attentiveness.

One refinement of the invention according to the examples provides that the respective predetermined finger gesture is intended to control a mobile terminal. In other words, the control device is configured to recognize in the camera data that the vehicle driver operates a mobile terminal. The control device can be configured to identify the mobile terminal in the camera data. The refinement gives rise to the advantage that the vehicle driver's attentiveness is established even when he or she is operating a mobile terminal and not a vehicle.

One refinement of the invention according to the examples provides that the control device is configured to detect the respective predetermined finger gesture of the vehicle occupant only in a predetermined micro-detection area. In other words, it is provided that the finger gesture is only identified as such by the control device if it is detected in the predetermined micro-detection area. It can thus be provided, for example, that finger movements are only detected if they are carried out in an area in front of the display screen interface. It can thus be provided, for example, that the finger movements are only detected when they are detected in the predetermined micro-detection area. It can thus be provided, for example, that a detected finger gesture is not identified as such when the hand rests on a center console, for example. The advantage thus results that conscious finger gestures can be distinguished from unconscious finger gestures.

One refinement of the invention according to the examples provides that the control device is configured to actuate the camera device in the specific degree of automation in order to increase a detection accuracy of the camera device in the micro-detection area. In other words, it can be provided that an aperture, an orientation, or a lens setting of the camera device is set in the specific degree of automation by the control device so that a resolution is improved within the micro-detection area. The advantage thus results that finger movements, which are smaller in scale in comparison to other gestures, can be more reliably detected within the micro-detection area by the control device.

One refinement of the invention according to the examples provides that the control device is configured to identify a predetermined body part of the vehicle occupant in the camera data and to define a location and/or dimension of the micro-detection area depending on a detected location of the body part. In other words, it is provided that the control device can detect at least the predetermined body part of the vehicle occupant, for example an arm or a hand, in the camera data. The control device can be configured to determine a location or dimension of the predetermined body part and to define the micro-detection area accordingly. It can be provided, for example, that the control device is configured to detect a location and dimension of a hand of the vehicle driver and to define the micro-detection area such that it is located around the hand. The control device can thereupon actuate the camera unit such that it is focused on the hand. The advantage thus results that the micro-detection area can be placed on the hand.

One refinement of the invention according to the examples provides that the control device is configured to identify the vehicle occupants and to detect the predetermined finger gesture depending on a user profile of the vehicle occupant. In other words, user profiles can be stored in the control unit which are assigned to respective vehicle occupants. The user profiles can comprise, for example, biometric data in order to identify a vehicle driver on the basis of his or her face. The control device is configured to identify the corresponding vehicle occupant and to detect the predetermined finger gesture, the predetermined finger gesture. The control device is also a type of manual for identifying the corresponding vehicle occupants and detecting the predetermined finger gesture which is stored for the vehicle driver in the user profile. It can be provided, for example, that a vehicle occupant is left-handed or right-handed and carries out corresponding finger gestures using the corresponding hand. It can also be provided that dimensions of the finger gestures can differ between the vehicle occupants.

The control device can comprise a data processing device or a processor device (processor circuit), which is configured to carry out an example method according to the invention. The processor device can comprise for this purpose at least one microprocessor and/or at least one microcontroller and/or at least one FPGA (Field Programmable Gate Array) and/or at least one DSP (Digital Signal Processor). In particular a CPU (Central Processing Unit), a GPU (Graphical Processing Unit), or an NPU (Neural Processing Unit) can each be used as a microprocessor. Furthermore, the processor device can comprise program code which is configured to carry out the example method according to the invention when executed by the processor device. The program code can be stored in a data memory of the processor device. The processor device can be based, for example, on at least one circuit board and/or on at least one SoC (System on Chip).

A second aspect of the invention according to the examples relates to a vehicle which comprises a driver monitoring device. The vehicle according to the examples of the invention may be configured as an automobile, in particular as a passenger vehicle or truck, or as a bus or motorcycle.

A third aspect of the invention according to the examples relates to a method for operating a driver monitoring device.

The method comprises a step of detecting a detection area of a vehicle cabin of a vehicle and sending corresponding camera data to a control device of the driver monitoring device by way of a camera device of the driver monitoring device.

The method comprises a step of checking a current degree of automation of the vehicle by way of the control device. If a specific degree of automation is present, a vehicle driver in the camera data is checked by the control device for meeting predetermined vehicle driver attentiveness criteria in order to establish a vehicle driver attentiveness if at least a minimum number of the vehicle driver attentiveness criteria are met and otherwise to determine that the vehicle driver attentiveness is not present.

One step of the method comprises receiving the camera data and identifying a respective predetermined finger gesture of the vehicle driver by way of the control device.

One step of the method comprises establishing meeting of one of the vehicle driver attentiveness criteria on the basis of the detection of the respective predetermined finger gesture by the control device.

One step of the method comprises establishing the vehicle driver attentiveness by way of the control device if it is established that at least a minimum number of the vehicle driver attentiveness criteria are met.

For applications or application situations which can result in the method and are not explicitly described here, it can be provided that according to the method an error message and/or a prompt to input user feedback is output and/or a standard-setting and/or a predetermined initial state is set.

A fourth aspect of the invention according to the examples relates to a program code which, when executed by a computer or a computer network, causes it to carry out an embodiment of the method according to the invention.

A fifth aspect of the invention according to the examples relates to a computer-readable storage medium, comprising program code which, when executed by a computer or a computer network, causes it to carry out an example method according to the invention. The storage medium can be provided at least partially as a nonvolatile data memory (for example, as a flash memory and/or as an SSD-solid-state drive) and/or at least partially as a volatile data memory (for example, as a RAM-random-access memory). The storage medium can be arranged in the computer or computer network. However, the storage medium can also be operated, for example, as a so-called app store server and/or cloud server on the Internet. A processor circuit having, for example, at least one microprocessor can be provided by the computer or computer network. The program code can be provided as binary code and/or as assembler code and/or as source code of a programming language (for example, C) and/or as program script (for example, Python). The computer-readable storage medium can alternatively be implemented by a signal having computer-readable data, for example a time-variant voltage signal and/or a radio signal.

The invention according to the examples also includes refinements of the vehicle according to the examples of the invention, the method according to the examples of the invention, the program code according to the examples of the invention, and the computer-readable storage medium which comprise features as have already been described in conjunction with the refinements of the driver monitoring device according to the examples of the invention. For this reason, the corresponding refinements of the vehicle according to the examples of the invention and the method according to the examples of the invention are not described once again here.

The invention according to the examples also comprises the combinations of the features of the described examples. The invention according to the examples thus also comprises implementations which each comprise a combination of the features of several of the described examples, provided that the examples have not been described as mutually exclusive.

### BRIEF DESCRIPTION OF THE DRAWINGS

Examples of the invention are described hereinafter. In the figures:

FIG. 1 shows a schematic representation of a driver monitoring device of a vehicle;

FIG. 2 shows a schematic representation of a detection of an attentiveness of a vehicle driver;

FIG. 3 shows a schematic representation of a method for operating a driver monitoring device;

FIG. 4 shows a further schematic representations of a representation of a method for operating a driver monitoring device; and

FIG. 5 shows a further schematic representations of a representation of a method for operating a driver monitoring device.

### DESCRIPTION

The examples explained hereinafter are examples of the invention. In the examples, the described components of the examples each represent individual features of examples of the invention to be considered independently of one another, which each also refine the examples of the invention independently of one another. The disclosure is therefore also intended to comprise combinations of the features of the examples other than those shown. Furthermore, the described examples can also be supplemented by other features of the examples of the invention which have already been described.

In the figures, identical reference signs each denote functionally identical elements.

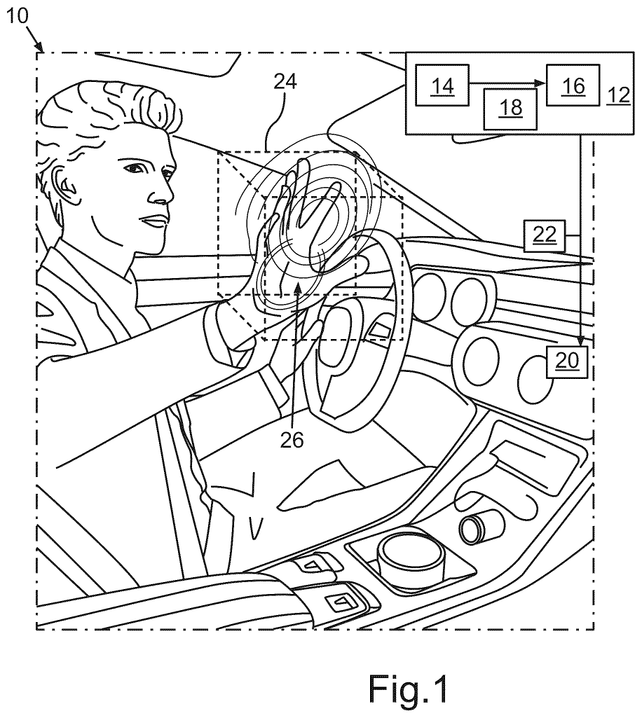

FIG. 1 shows a schematic representation of a driver monitoring device 12 of a vehicle 10.

A vehicle cabin is shown, in which a vehicle driver of the vehicle 10 can be located. The driver monitoring device 12 can comprise a camera device 14, which can comprise one or more camera units for detecting the vehicle interior. The camera device 14 can generate corresponding camera data 18 and provide these data to a control device 16. The control device 16 can be configured to identify gestures of the vehicle driver in the camera data 18 and output commands linked with the gestures.

The vehicle 10 can be configured to be operated in different degrees of automation. It can be provided that the control device 16 is configured to determine the current degree of automation of the vehicle 10. It can be provided that in a specific degree of automation, it is necessary to monitor the vehicle driver for attentiveness in order to be able to ensure an intervention of the vehicle driver if needed. The control device 16 can be configured to check whether at least two vehicle driver attentiveness criteria are met by the vehicle driver within a period of time of 30 seconds. The control device 16 is configured to establish a vehicle driver attentiveness if the at least two vehicle driver attentiveness criteria are present. The control device 16 can be configured to determine that the vehicle driver is not attentive and to output a warning signal if the at least two vehicle driver attentiveness criteria are not met.

It can be provided that the control device 16 is configured to authorize a specific application in the predetermined degree of automation of the vehicle 10, which is blocked in other degrees of automation. The application can be, for example, an entertainment application, which is displayed on a user interface 20 of the vehicle 10. The control device 16 can activate a recognition of specific finger gestures 26 upon establishing the specific degree of automation. In other words, the control device 16 is configured to permit the vehicle driver to use the application and to control it by finger gestures 26 if the predetermined degree of automation is present.

The control device 16 can be configured, upon activation of the specific degree of automation, to define a micro-detection area 24, which can be located around a hand or a smart phone of the vehicle driver. The control device 16 can recognize the finger gestures 26 within the micro-detection area 24. The control device 16 can actuate the application upon recognition of the finger gesture 26. It can additionally be provided that the detection of the finger gesture 26 can be assessed by the control device 16 as meeting an attentiveness criterion by the vehicle driver. It can be provided, for example, that the attentiveness of the vehicle driver is established by the control device 16 if his or her eyes are open and he or she carries out the finger gesture 26 within the micro-detection area 24 around his or her smart phone.

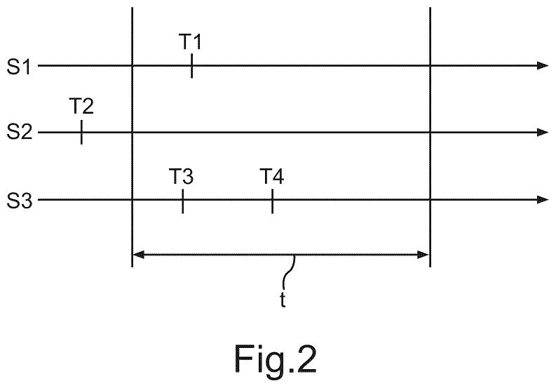

FIG. 2 shows a schematic representation of a detection of an attentiveness of a vehicle driver.

A moving time window ‘t’ of 30 seconds is shown. The timeline shows three tracks which are assigned to respective vehicle criteria. A first of the tracks can indicate times at which a blinking movement of the vehicle driver is detected in the camera data 18 by the control device 16.

A second of the tracks can indicate times at which a predetermined head movement of the vehicle driver is detected in the camera data 18 by the control device 16.

A third of the tracks can indicate times at which a predetermined finger gesture 26 of the vehicle driver is detected in the camera data 18 by the control device 16.

The case can occur that at a first time, which is within the 30-second window, the blinking movement of the vehicle driver is detected, and therefore the availability criterion with respect to an eye detection is met. At a second time, which is outside the 30-second window, a specific head movement can be detected by the control device 16, due to which the second attentiveness criterion with respect to the head movements is not met. At a third time and a fourth time, finger gestures 26 for operating a vehicle interface can be detected by the control device 16. The two times can be within the 30-second window, so that the availability criterion with respect to the finger gestures 26 is met. As a result of the availability criterion with respect to the eye detection and the availability criterion relating to the finger gestures 26 being met, the vehicle driver availability is established by the control device 16.

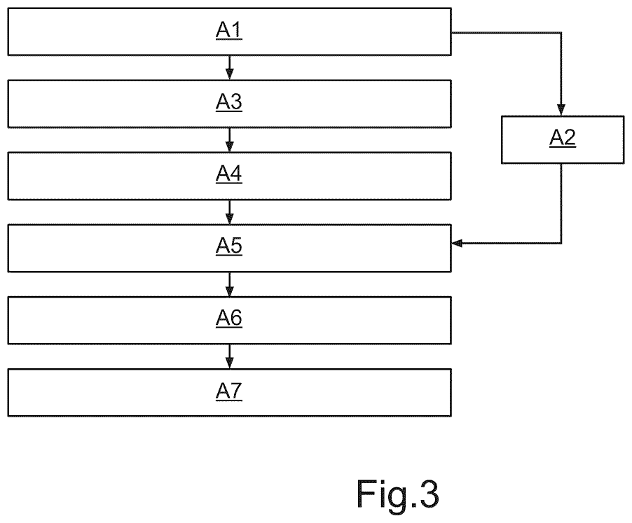

FIG. 3 shows a schematic representation of a method for operating a driver monitoring device 12.

In a first step A1 of the method, an activation of a specific degree of automation of the vehicle 10 can be detected by the control device 16. The control device 16 can thereupon initiate the monitoring of the vehicle driver for his or her vehicle driver attentiveness.

The control device 16 can authorize A2 a use of an application of the vehicle 10 with recognition of the activation of the predetermined degree of automation.

In a third step A3, the control device 16 can recognize that a connection is established between the user interface 20 and a mobile terminal in order to enable a use of the application.

In a fourth step A4, a mirroring of a content of the smart phone on the user interface 20 can be initiated.

In a fifth step A5, an activation of a gesture control of the smart phone or the user interface 20 can be activated by finger gestures 26 within a micro-detection area 24.

In a sixth step A6, the control device 16 can determine a position of the mobile terminal and direct a focus of the camera device 14 on the mobile terminal in order to increase a detection accuracy around the smart phone. The micro-detection area 24 can be shifted by the control device 16 such that it surrounds the mobile terminal.

The control device 16 can, in a step A7, detect the finger gestures 26 within the micro-detection area 24 in order to control the smart phone or the application on the user interface 20. The control device 16 can assess the detected finger gestures 26 as meeting an attentiveness criterion.

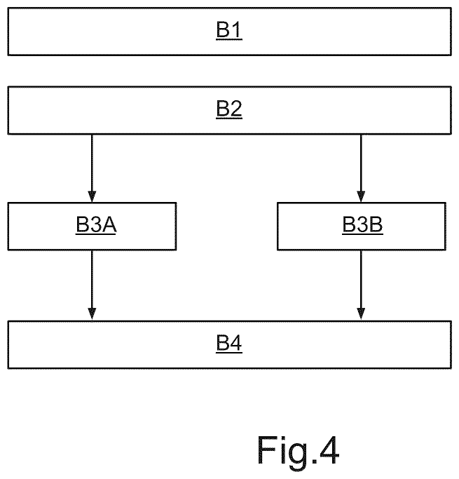

FIG. 4 shows a further schematic representations of a representation of a method for operating a driver monitoring device 12.

In a first step B1, the control device 16 can activate the detection of the finger gestures 26.

In a second step B2, a selection of a micro-detection area 24 can take place, within which the finger gestures 26 are identified as such by the control device 16. It is possible here that the vehicle driver, by way of a manual selection of his or her hand used in the user interface, places B3A the micro-detection area 24 on either his/her left hand or right hand.

Alternatively thereto, a camera-based selection of the preferred hand can take place B3B, wherein an identity of the vehicle driver is identified by the control device 16 in the camera data 18 and the preferred hand stored in a vehicle driver profile of the vehicle driver is selected.

In a following step B4, the control device 16 can actuate the camera device 14 in order to place a camera focus on the respective hand or the respective finger of the vehicle driver.

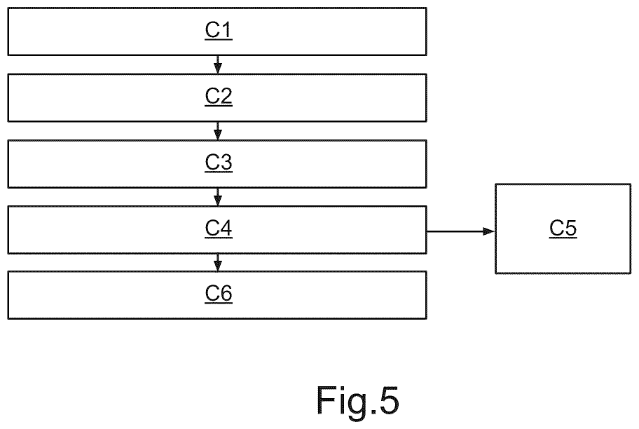

FIG. 5 shows a further schematic representations of a representation of a method for operating a driver monitoring device 12.

A first step of the method C1 can comprise an actuation of the camera device 14 by the control device 16, wherein a camera focus of the camera device 14 is placed on hands or fingers of the vehicle driver.

In a second step C2, a detection accuracy can be increased in order to enable a small-scale resolution of finger movements.

In a third step C3, a gesture control for enabling a control of a smart phone on a vehicle display screen can be activated by the control device 16.

In a further step C4, detected finger gestures 26 can be identified and categorized.

In a fifth step C5, control commands can be output by the control device 16 depending on the detected finger gesture 26.

In addition, learning of a vehicle driver profile can be carried out at C6 by the control device 16, based on the detected finger gestures 26, in order to describe the vehicle-driver-specific finger gestures 26 and optimize detection parameters in the vehicle driver profile.

The general example object of the invention is to create a (cost-neutral, safe, and rapid) solution for the current and coming vehicle generation(s) which permits the vehicle driver to control applications in the vehicle 10 with active autonomous driving function by gesture control at a small scale—in particular by a “scrolling movement” with the thumb (index finger) or “swiping” to the side with the thumb (index finger). See FIG. 5 for the representation of the scrolling movement on the smart phone.

It is fundamentally unimportant here whether the application is provided by mirroring of the smart phone on the vehicle display screen or is represented by the vehicle 10-SW itself.

The basic principle of the application for the invention according to the examples is the combination of an automated driving function with the small-scale gesture control of an (entertainment) application.

FIG. 3 shows a method. First the automated driving function (SAE level 3 or higher) is activated. The smart phone can then be connected to the vehicle 10. This can also take place in the reverse sequence in principle. The display screen of the smart phone is then mirrored on a display screen of the vehicle 10. Alternatively, an application of the vehicle operating system can also be used. In a next step, the gesture control of the app is activated in the vehicle menu/by speech control. The interior camera of the vehicle 10 can then place the focus on the hands to be able to detect the finger movements in detail. This enables the gesture control by finger movement for various applications such as scrolling with the finger “in the air” as otherwise in the vehicle 10, for example to scroll through social media or read a newspaper.

The essential and special features (respectively differences) as compared with existing solutions is the combination of a gesture control similar to smart phone operation in the vehicle driver-vehicle interaction in the context of an automated driving function by using the vehicle interior cameras.

The described examples perceptibly improve the ability to handle apps during the journey with an active automated/autonomous driving function. The essence and the novelty of the invention according to the examples is that the utility of the automated/autonomous driving function is enhanced (at equal costs) due to the better usability of (social media) applications and in general an improvement of the gesture control is enabled.

Due to a good interaction of vehicle 10 and vehicle driver, the added value of the automated driving function as such is perceptibly enhanced and potential gains are maximized.

A further advantage of the technical implementation is that in principle no further resources are required. The solution offers an implementation (respectively solution) with the aid of existing hardware and software and some ML applications for gesture classification. A cost-reduction can be provided by retaining existing sensors and microcontrollers and therefore also the software architecture/configuration thereof. Since this method is implemented in particular in the form of software, it can be distributed via update or upgrade to existing software or firmware.

The method can even be installed later via update and offers us the possibility of buying software. The required hardware such as interior cameras are required in any case for the vehicle driver monitoring of other functions which are already implemented.

The combination of the interior monitoring and changing the camera focus to implement the finger gesture control for apps in the vehicle 10 with active automated/autonomous driving function is novel in this context.

These methods could be integrated into known control devices 16 and require neither new hardware nor new protocols.

The technical implementation can be configured as follows:

In the basic principle, the activation of the automated driving function is already described in combination with the connection of the smart phone to the vehicle display and the interaction with an app and the resulting added value.

The setting of the gesture control will be described once again in more detail as illustrated in FIG. 4. For this purpose, it is reasonable to define the preferably used hand for the use of the small-scale gesture control in the vehicle 10 in order to then be able to implement this, and to be able to orient the camera accordingly. The selection of the preferably used hand can be carried out either manually by the selection in the vehicle menu by the user or a camera-based automatic selection takes place based on the first gestures—for this purpose the customer is first used in a larger focus, which can possibly result in some inaccuracies until the definition of the preferred hand. The camera focus is then placed on the respective hand used or the fingers.

This enables a small-scale resolution of the finger movements and an improved recognition of the movements of the focused hand as illustrated in FIG. 5. The gesture control of the smart phone or the app is thus enabled. For better understanding, the movement can also be visualized to the user in the vehicle display—what is meant by this is, for example for a scrolling movement, a visualized strip on the right-hand edge of the display screen. After the execution and recognition of the gesture, the categorization of the gesture into, for example, scrolling or swiping movements takes place. In order to continuously improve the system for recognizing and categorizing the gestures into scrolling movements with the index finger (from top to bottom) and swiping movements to the side (for example, all fingers), user-based machine learning of the meaning of the gestures or the categorization thereof takes place. An existing user account of the vehicle driver can be used for the user-based categorization. If no user should be present, a general non-user-based learning system can be used. After the categorization of the gesture, a differentiated reaction takes place depending on the gesture.

Overall, the Examples Show How a Recognition of Small-scale Gestures Can Be provided.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ 2d 1865 (Fed. Cir. 2004).

1. A driver monitoring device for a vehicle, comprising:
a camera device; and
a control device,
wherein
the camera device configured to detect a detection area of a vehicle cabin of the vehicle and to send camera data of the camera device to the control device,
the control device configured to,
receive the camera data to identify gestures of a vehicle driver within the detection area according to a gesture database stored for the control device,
check a current degree of automation of the vehicle,
if a specific degree of automation is present according to the current degree of the automation of the vehicle, checking the vehicle driver in the camera data for meeting a vehicle driver attentiveness criteria among a plurality of vehicle driver attentiveness criteria, and
if at least a minimum number of vehicle driver attentiveness criteria among the plurality of vehicle driver attentiveness criteria is met according to the checking of the vehicle driver in the camera data, establish a vehicle driver attentiveness and otherwise determine that the vehicle driver attentiveness is not present,
wherein a vehicle driver attentiveness criteria among the plurality of vehicle driver attentiveness criteria includes a detection, by the control device, of a finger gesture of the vehicle driver among the gestures of the vehicle driver.

2. The driver monitoring device according to claim 1, wherein the finger gesture is detected for a control of a function of a display screen user interface, which is authorized by the control device only in the specific degree of automation.

3. The driver monitoring device according to claim 2, wherein the finger gesture is for a control of the display screen user interface of a mobile terminal.

4. The driver monitoring device according to claim 2, wherein the control device is configured to detect the finger gesture of the vehicle driver only in a micro-detection area among areas in the vehicle cabin.

5. The driver monitoring device according to claim 4, wherein
the control device is configured to actuate the camera device in the specific degree of automation to increase a detection accuracy of the camera device in the micro-detection area.

6. The driver monitoring device according to claim 4, wherein
the control device is configured to identify a body part of the vehicle driver in the camera data and to define a location and/or dimension of the micro-detection area depending on a detected location of the body part.

7. The driver monitoring device according to claim 1, wherein the control device is configured, upon the detection of the finger gesture of the vehicle driver, to actuate a mobile terminal communicationally coupled with a display screen user interface of the vehicle.

8. The driver monitoring device according to claim 1, wherein the control device is configured to identify the vehicle driver, and to detect the finger gesture depending on a user profile of the vehicle driver.

9. A vehicle, comprising a driver monitoring device according to claim 1.

10. A method of operating a driver monitoring device in a vehicle, comprising:
detecting, by a camera device, a detection area of a vehicle cabin of the vehicle and sending camera data of the camera device to a control device;
by a control device configured to execute a process including,
receiving the camera data to identify gestures of a vehicle driver within the detection area according to a gesture database stored for the control device;
checking a current degree of automation of the vehicle, such that the vehicle driver is checked in the camera data for meeting a vehicle driver attentiveness criteria, among a plurality of vehicle driver attentiveness criteria, upon a presence of a specific degree of automation according to the current degree of automation of the vehicle;
if at least a minimum number of vehicle driver attentiveness criteria among the plurality of vehicle driver attentiveness criteria is met according to the vehicle driver being checked in the camera data, establishing a vehicle driver attentiveness and otherwise determine that the vehicle driver attentiveness is not present;
detecting a finger gesture of the vehicle driver among the gestures of the vehicle driver, in the camera data and establishing that one vehicle driver attentiveness criteria among the plurality of vehicle driver attentiveness criteria is met; and
if the minimum number of vehicle driver attentiveness criteria includes the one vehicle driver attentiveness criteria based on the finger gesture of the vehicle driver detected, establishing the vehicle driver attentiveness and otherwise determining that the vehicle driver attentiveness is not present.

11. A non-transitory computer-readable storage medium, comprising:
a program code which, when executed by a computer or a computer network, is configured to execute the method according to claim 10.
